(19) United States
(12) Patent Application Publication
(10) Pub. No.: US 2003/0051519 A1
(43) Pub. Date: Mar. 20, 2003

(54) Automobile steering lock

(76) Inventor: Tian-Yuan Chen, Chung Ho City (TW)

Correspondence Address: Tian-Yuan Chen, P.O. Box 90, Tainan City, 704, TW

(21) Appl. No.: 09/953,169

(22) Filed: Sep. 17, 2001

(51) Int. Cl. F16C 3/00

(52) U.S. Cl. 70/209

(57) ABSTRACT

An automobile steering lock includes an elongate body, a locking deadbolt, a locking unit, and an engage member. The engage member has an elongate insert groove to cover on a portion of the steering wheel of an automobile. The body is rotated with a rotatable member as a pivot until the bottom of the body rests on the portion of the steering wheel. Then an insert plate of the engage member fits in the engage groove of the body, and an insert member of the locking deadbolt is moved to protrude in the insert opening of the rotatable member of the engage member, with the end of the elongate rod of the body resting on the gauge panel of an automobile, preventing the stirring wheel from rotated for any angle, preventing the automobile from stolen.

### BACKGROUND OF THE INVENTION

1. Field of the Invention

This invention relates to an automobile steering lock, particularly to one having an elongate body with an elongate rod extending toward the gauge panel, with a portion of the steering wheel of an automobile surrounded by an engage member and the bottom of a front portion of the elongate body, prohibiting the steering wheel to turn for any angle, attaining the objective of preventing the automobile from stolen.

2. Description of the Prior Art

A known conventional steering lock shown in FIG. 1, includes an elongate body 10, a steel bead 11, a spring 12, and a cover 13 orderly fitted in one side of a locking member base fixed with one end of the body 10, and a locking member 14 combined on the locking member base. The elongate body 10 has a hook 15 extending down from an upper portion to hook an outer edge of a steering wheel, Further, an elongate rod 16 telescopes in the locking member base and the elongate body 10, having a plurality of annular groove 161 formed near an upper end, and a hook 160 formed in an upper end. Then the elongate body functions as a blocking arm.

In using the conventional steering lock on the steering wheel of an automobile, the steering lock is placed on the steering wheel, with the hook 15 first hooked an outer edge of the steering wheel and then with the hook 16 hook an inner edge of the steering wheel by telescoping the elongate rod 16 outward. Then the elongate body extends toward between the driver's seat and the steering wheel to restrict the steering wheel in its rotating angle. But there is still a large space between the elongate body, the driver's seat and the windshield so the stealer can move the seat backward to handle the steering wheel to steal the automobile.

### SUMMARY OF THE INVENTION

The objective of the invention is to offer an automobile steering lock, surely and stably locking the steering wheel unable to be rotated completely.

The feature of the invention is an elongate body with an elongate rod, a locking deadbolt contained in a first chamber of the body and moved by a locking unit fixed in a second chamber of the body and having a locking member to move the locking deadbolt to insert in an insert opening of a rotatable member of an engage member fitted around a portion of the steering wheel, Then the elongate body is rotated to let the bottom of the body rest on the portion of the steering wheel of an automobile, with the end of the elongate rod resting on the gauge panel, preventing the steering wheel from rotated. Thus the steering lock prevents an automobile from stolen.

### BRIEF DESCRIPTION OF DRAWINGS

This invention will be better understood by referring to the accompanying drawings, wherein:

FIG. 1 is an exploded perspective view of a known conventional automobile steering wheel;

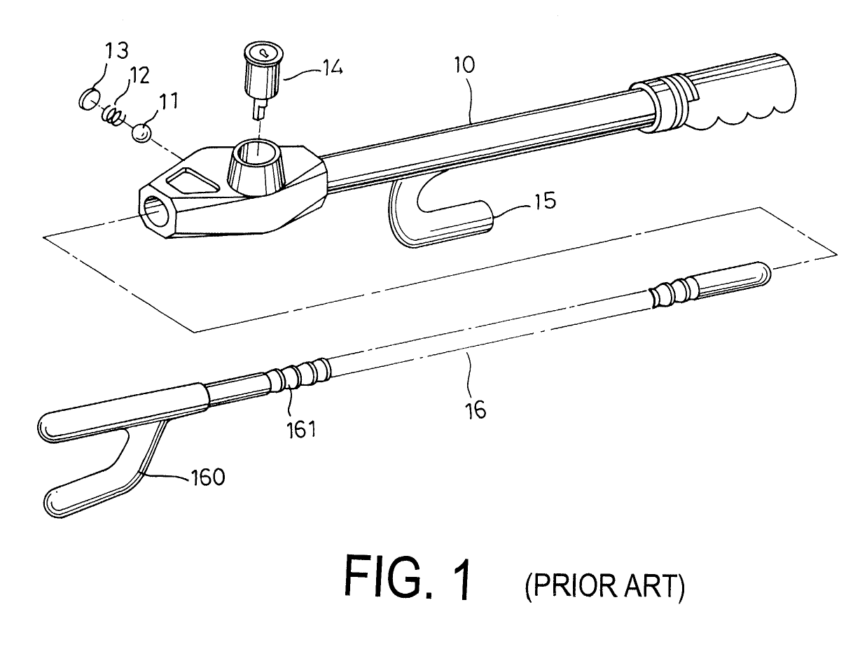

FIG. 2 is an exploded perspective view of an automobile steering lock in the present invention;

FIG. 3 is a perspective view of the automobile steering lock in the present invention;

FIG. 4 is a cross-sectional view of the automobile lock in the present invention, showing it locking on the steering wheel of an automobile;

FIG. 5 is a side view of an engage member of the automobile steering lock in the invention fitting with the body of the steering wheel;

FIG. 6 is a cross-sectional view of the automobile steering lock in an unlocked condition in the present invention; and,

FIG. 7 is a perspective view of the automobile steering lock in a locking condition in the present invention.

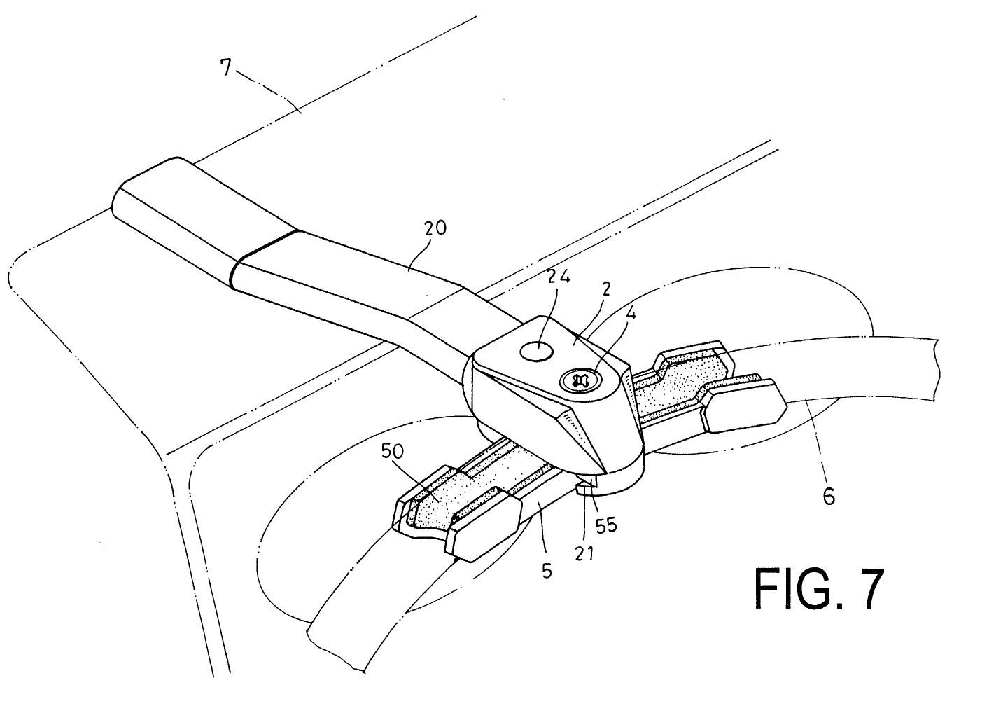

### DETAILED DESCRIPTION OF THE PREFERRED EMBODIMENT

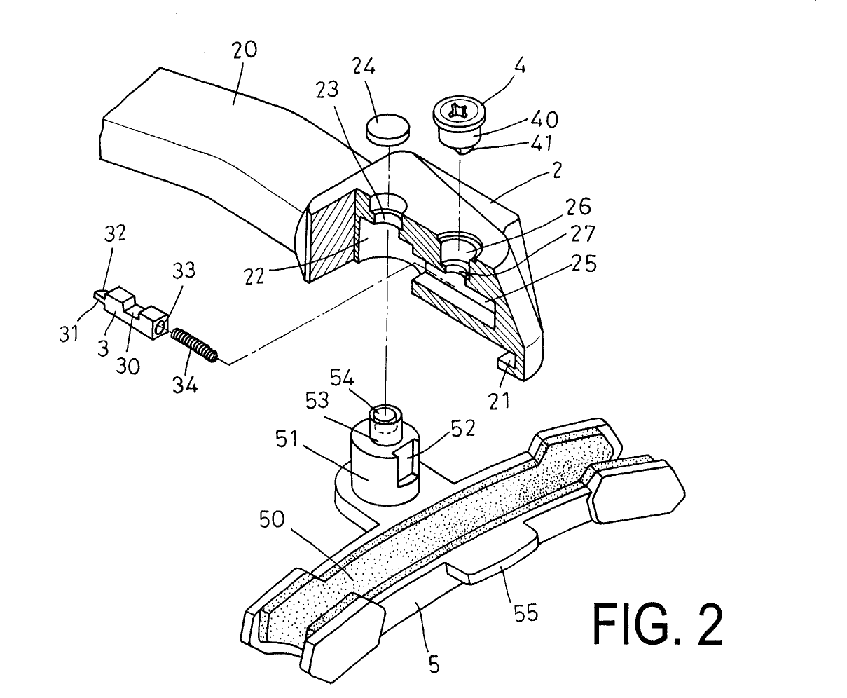

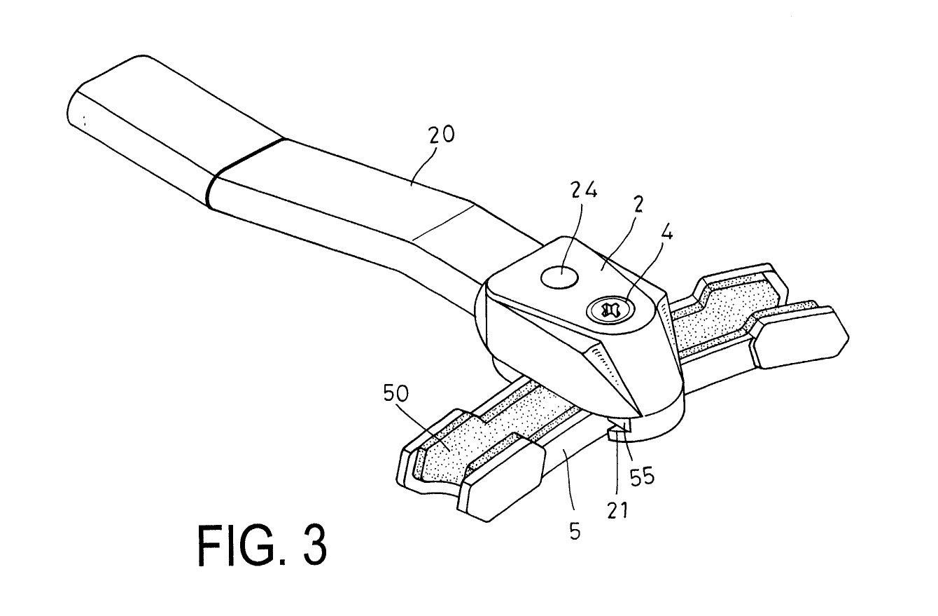

A preferred embodiment of an automobile steering lock in the present6 invention, as shown in FIGS. 2 and 3, includes an elongate body 2, a locking deadbolt 3, a lock unit 4, an engage member 5 as main components combined together.

The elongate body 2 has an elongate rod 20 formed in a rear portion and extending from a front portion, an engage groove 21 formed in a bottom of said front portion, a vertical shaft hole 22 formed in the bottom, a stepped hole 23 formed in an upper surface of the front portion and communicating with the shaft hole 22, a cover closing up the stepped hole 23, a first chamber 25 formed in the sidewall of the shaft hole 22, a second chamber 26 formed in an upper surface, a hole 27 bored between the second chamber 26 and the first chamber 25.

The locking deadbolt 3 is fitted in the first chamber 25 of the body 2, having a recess 30, a thin insert member 31 with a cut face 32 formed in a front end, a hole 33 bored in a rear end surface, and a spring 34 having a front end fitted in the hole 33 to elastically push forward the locking deadbolt 3.

The lock unit 4 is firmly fixed in the second chamber 26 of the body 2, having a rotatable locking member 40 with a lower small locking member 41 to fit in the recess 30 of the locking deadbolt 3.

An engage member 5 is pivotally connected to the bottom of the body 2, having an elongate engage groove 50 formed in a front upper portion, and a rotatable member 51 formed in a rear portion. The rotatable member 51 has an annular wall and an insert opening 52 formed in the annular wall, and a short post 53 of a small diameter fixed on an upper wall covering the annular wall and a recess 54 formed in an upper end of the post 53. Further a horizontal insert plate 55 formed to extend forward from a center upper outer edge of the engage member 5.

In assembling, referring to FIGS. 2, 3 and 4, the locking deadbolt 3 and the spring 34 are orderly inserted in the first chamber 25 of the body 2, and then the locking unit 4 is deposited in the second chamber 26, with the lower small locking member 41 protruding in the hole 27 of the body 2 and inserting in the recess 30 of the locking deadbolt 3 so as to stabilize the locking deadbolt 3 in the first chamber 25. Next, the rotatable member 51 of the engage member 5 is inserted in the vertical shaft hole 22 of the body 2 from under, with the short post 53 fitting in the stepped hole 23. Then the recess 54 of the short post 53 is compressed in the stepped hole 23, pivotally connecting the engage member 5 to the bottom of the body 2. Then the cover 24 is closed up the stepped hole 23, finishing assembly of the steering lock.

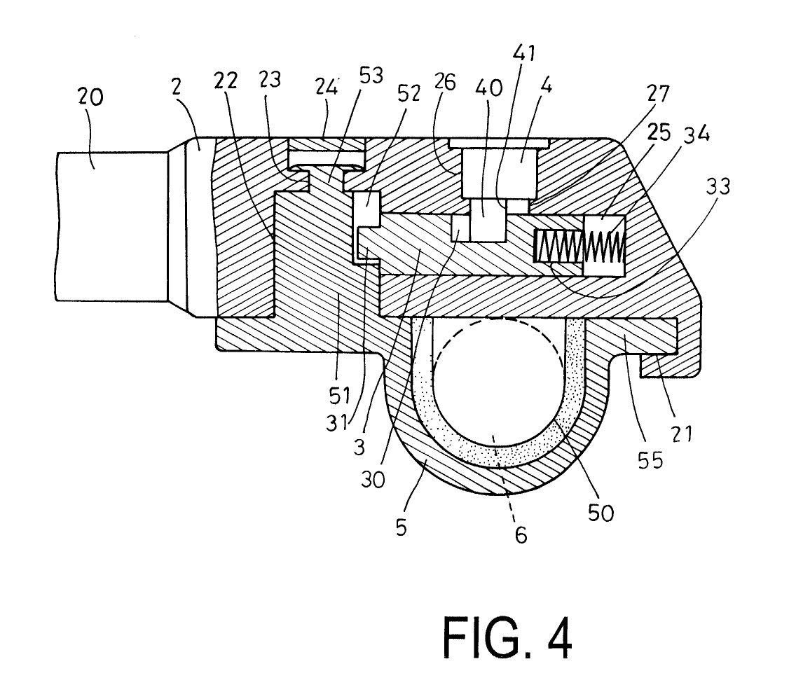

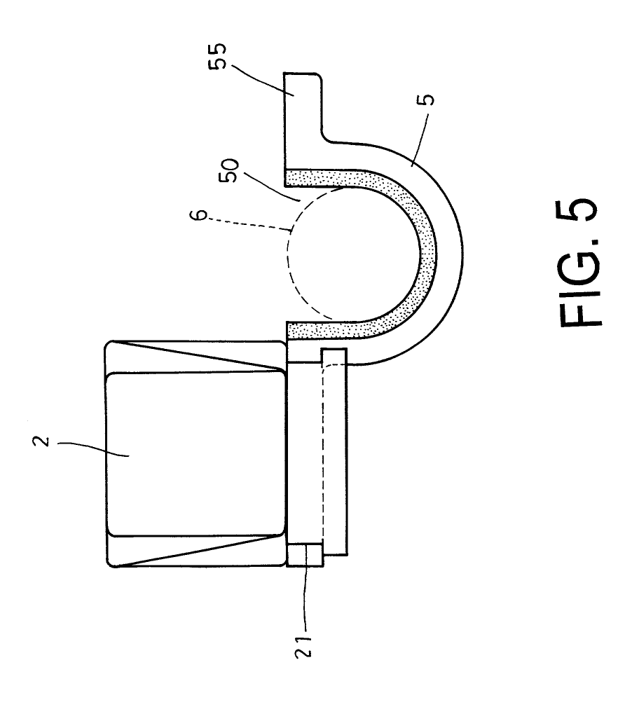

When the steering lock is to be locked on the steering wheel of an automobile, as shown in FIGS. 4 and 5, the engage groove 50 of the engage member 5 is placed on a portion of the steering wheel 6of an automobile, and the body 2 is rotated with the rotating member 51 as a pivot, to let the bottom of the body move to contact an upper edge of the steering wheel 6, surrounding the portion of the steering wheel 6 not separating from the steering lock. Then the insert plate 55 of the engage member 5 fits in the engage groove 21 of the body 2, with the insert opening 52 aligned to the locking deadbolt 3, which is then pushed by the spring 34 to move outward to let the insert member 31 protrude in the insert opening 52, locking completely the steering lock on the steering wheel 6, with the end of the rod of the body 2 resting on the gauge panel 7 of the automobile, keeping the elongate body immovable. Therefore, the steering wheel is prevented from rotating in any angle; also the automobile is prevented from stolen.

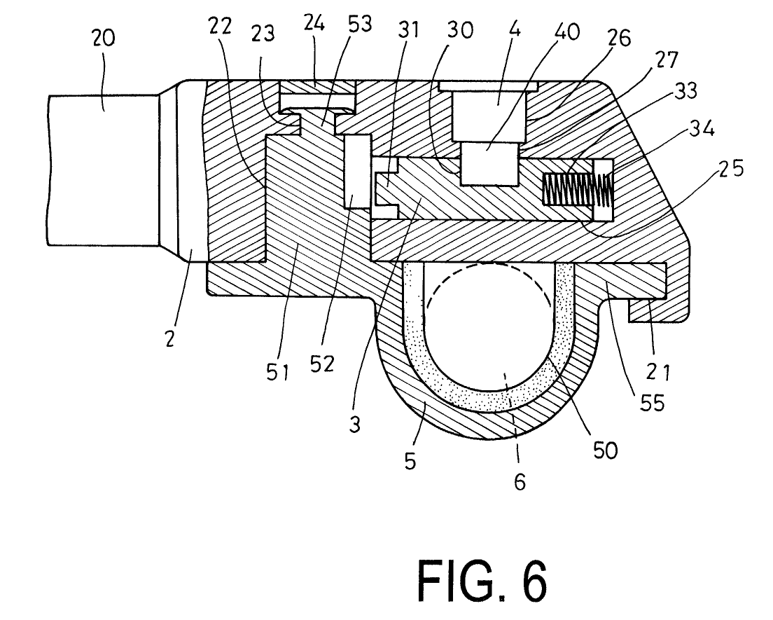

If the steering lock is to be unlocked from the locked condition, as shown in FIG. 6, first the key of the lock is used to rotate the locking member 40 of the locking unit 4 for a certain angle, forcing the lower small locking member 41 push the recess 30 of the locking deadbolt 3 to move the locking deadbolt 3 to move inward in the in first chamber 25 to compress the spring 34, with the insert member 31 separating from the insert opening 52 of the rotatable member 51 of the engage member 5 so that the body 2 can be rotated with the rotatable member 52 as a pivot, and then the insert plate 55 of the engage member 5 disengages from the engage groove 21 of the body 2. Then the bottom of the front portion of the body 2 does not rest on the portion of the steering wheel 6 as shown in FIG. 5, permitting the steering lock may be taken off the steering wheel 6.

While the preferred embodiment of the invention has been described above, it will be recognized and understood that various modifications may be made therein and the appended claims are intended to cover all such modifications that may fall within the spirit and scope of the invention.

I claim:

1. An automobile steering lock comprising:
an elongate body having an elongate rod formed to extend rearward from a front portion, said front portion having a bottom formed with an engage groove, said bottom provided with a vertical shaft hole, said front portion having a stepped hole formed in an upper surface and communicating with said vertical shaft hole, a cover closing on said stepped hole, a first chamber formed in a sidewall of said vertical shaft hole, a second chamber formed in the upper surface, a hole formed under said second chamber and communicating with said first chamber;
a locking deadbolt contained in said first chamber of said body, having a recess formed in a center upper surface, a thin insert member formed to extend forward, said insert member having a cut face, a hole bored in a rear end surface for one end of a spring to fit therein to elastically push said locking deadbolt move forward;
a locking unit fixed firmly in the second chamber of said body, having a rotatable locking member with a small lower locking member provided with a sloped face said small lower locking member fit in said recess of said locking deadbolt to move forward said locking deadbolt to insert in an insert member of an engage member to lock said engage member keeping a portion of the steering wheel from separating from said steering lock;
said engage member pivotally connected to the bottom of said body, having an elongate engage groove formed in an elongate front portion and fitting around a portion of the steering wheel of an automobile, said rotatable member formed in a rear portion extending from a center section of the elongate front portion, said rotatable member having an annular wall and said insert opening formed in the annular wall, a small short post fixed on an upper wall closing said annular wall, said front portion having a horizontal insert plate extending forward from a center upper front edge; and,
said elongate groove of said engage member fitted around and covered on a portion of the steering wheel of an automobile, said body rotated with said rotatable member as a pivot until a bottom of said body rests on the portion of the steering wheel, said insert plate of said engage member fitting in said engage groove of said body, said thin insert member of said locking deadbolt inserting in said insert opening of said rotatable member, said elongate rod of said body resting on a gauge panel of an automobile so as to prevent the steering wheel of the automobile from rotating for any angle, thus said steering lock preventing the automobile from stolen.
